(19) United States
(12) Patent Application Publication
(10) Pub. No.: US 2004/0070259 A1
(43) Pub. Date: Apr. 15, 2004

(54) Vehicle wheel assembly

(76) Inventor: Ya-Wen Chuang, Bade City (TW)

Correspondence Address: PRO-TECHTOR INTERNATIONAL SERVICES, 20775 Norada Court, Saratoga, CA, 95070-3018, US

(21) Appl. No.: 10/272,025

(22) Filed: Oct. 15, 2002

(51) Int. Cl. B60B 7/00

(52) U.S. Cl. 301/37.101

(57) ABSTRACT

A vehicle wheel assembly includes a wheel made of aluminum alloy and an annular protective cover made of stainless steel. The wheel includes a central hub, a plurality of spokes extending radially outward from the central hub, and a rim. The rim has a front portion, a rear portion, and an intermediate recessed portion. The intermediate recessed portion of the rim includes an inner wall with which a distal end of each spoke is integrally formed. A front annular flange extends outward from the front portion of the rim and has a front circumferential surface and an outer circumferential edge. The annular protective cover presses against an inner wall of the front portion of the rim and envelopes the front circumferential surface and the outer circumferential edge of the front annular flange.

### BACKGROUND OF THE INVENTION

1. Field of the Invention

The present invention relates to a vehicle wheel assembly. In particular, the present invention relates to a vehicle wheel assembly including a wheel made of aluminum alloy and a stainless protective cover attached to a side of the wheel.

2. Description of the Related Art

Wheels for automobiles generally include steel plate type, steel spoke type, and aluminum alloy type. Aluminum alloy wheels are light and thus can be used with wider tires while providing excellent heat conductivity as well as a shining effect. A typical aluminum alloy wheel is made by formed of gravity casting and includes a central hub and a plurality of spokes extending radially outward from the central hub to integrally connect with a rim. Two flanges respectively extend outward along a longitudinal axis from front and rear ends of the rim, thereby defining a space for mounting a rubber tire around the rim.

After formation by casting, an aluminum alloy wheel is subject to several procedures of grinding and polishing to obtain a shining appearance. However, after a period of time, the shine of the appearance of the aluminum alloy wheel deteriorates, particularly at the inner wall of the front portion of the rim and at the front circumferential surface of the flange on the front end of the rim. Further, the front side of the rim facing an outer side of the automobile is exposed and thus aggravates deterioration. Thus, the automobile as a whole no longer provides an aesthetically pleasing effect.

### SUMMARY OF THE INVENTION

An object of the present invention is to provide vehicle wheel assembly including a wheel made of aluminum alloy and a stainless protective cover attached to a side of the wheel. The stainless protective cover covers a portion of a rim of the wheel. The stainless protective cover is less likely to deteriorate and thus provides an aesthetically pleasing effect by the shining stainless for a long time. Further, the stainless protective cover increases surface strength of the wheel.

A vehicle wheel assembly in accordance with the present invention comprises a wheel made of aluminum alloy and an annular protective cover made of stainless steel. The wheel includes a central hub, a plurality of spokes extending radially outward from the central hub, and a rim. The rim has a front portion, a rear portion, and an intermediate recessed portion. The intermediate recessed portion of the rim includes an inner wall with which a distal end of each spoke is integrally formed. A front annular flange extends outward from the front portion of the rim and has a front circumferential surface and an outer circumferential edge. The annular protective cover presses against an inner wall of the front portion of the rim and envelopes the front circumferential surface and the outer circumferential edge of the front annular flange.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a vehicle wheel assembly in accordance with the present invention.

FIG. 2 is a perspective view of an aluminum alloy wheel of the vehicle wheel assembly in FIG. 1.

FIG. 3 is a perspective view of a stainless protective cover of the vehicle wheel assembly in FIG. 1.

FIG. 4 is an enlarged sectional view of a portion of the vehicle wheel assembly in FIG. 1.

FIG. 5 is a further enlarged sectional view illustrating a final product of the vehicle wheel assembly in FIG. 4.

### DETAILED DESCRIPTION OF THE PREFERRED EMBODIMENT

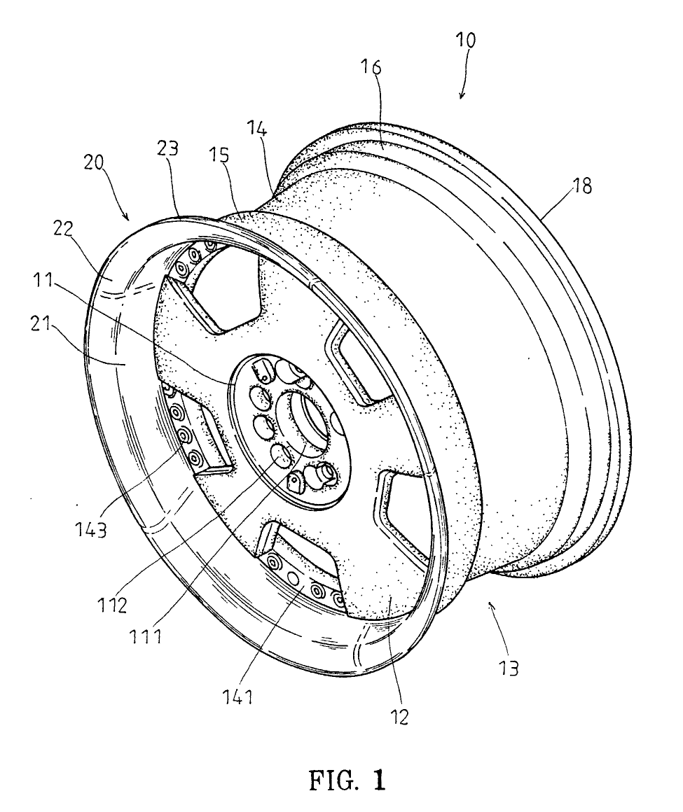

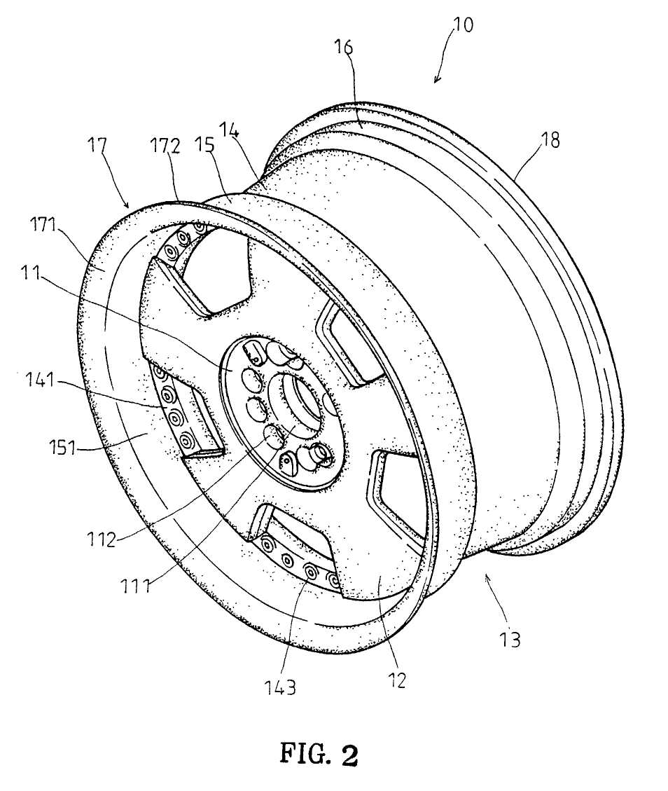

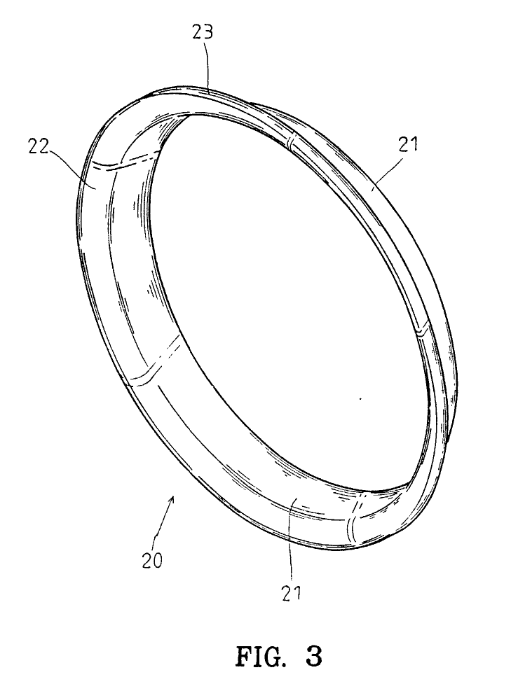

Referring to FIGS. 1 through 3, a vehicle wheel assembly in accordance with the present invention generally comprises a wheel 10 (FIG. 2) made of aluminum alloy and an annular protective cover 20 (FIG. 3) made of stainless steel. The aluminum alloy wheel 10 is formed by means of gravity casting. The protective cover 20 is formed by means of drawing a stainless plate. Then, the protective cover 20 is attached by hydraulic means to a front side of the aluminum alloy wheel 10.

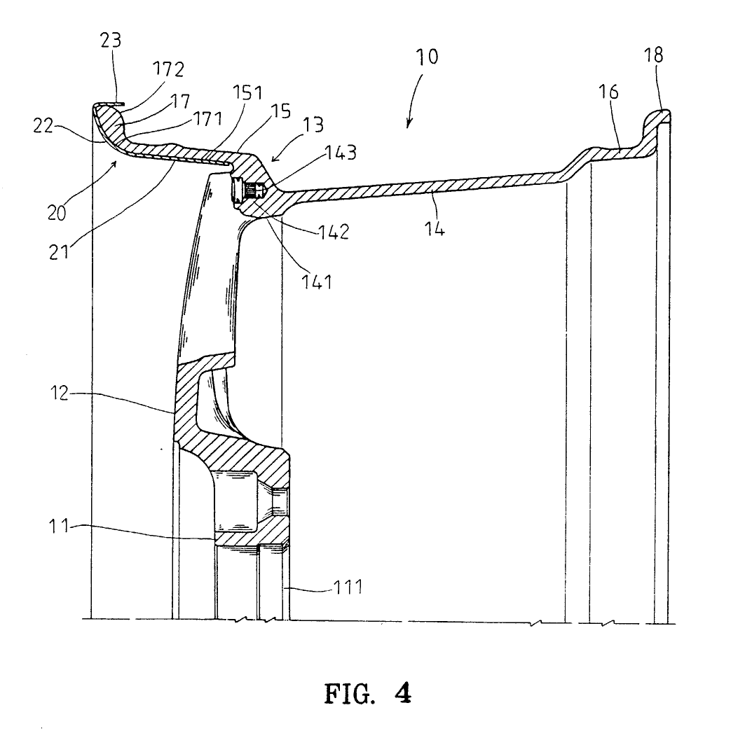

Referring to FIG. 2, the aluminum alloy wheel 10 includes a central hub 11, a plurality of spokes 12 extending radially outward from the central hub 11, and a rim 13 having a front portion 15, a rear portion 16, and an intermediate recessed portion 14. The intermediate recessed portion 14 of the rim 13 includes an inner wall 141 with which a distal end of each spoke 12 is integrally formed. The central hub 11 includes a mounting hole 111 in a center thereof and a plurality of fixing holes 112 around the mounting hole 111, thereby allowing attachment of the central hub 11 to an axle (not shown) of an automobile (not shown). The inner wall 141 of the intermediate recessed portion 14 of the rim 13 includes a plurality of spaced holes 142 (FIG. 4) into which a plurality of decorative bolts 143 are respectively inserted.

The rim 13 further includes a front annular flange 17 projecting outward from the front portion 15 and a rear annular flange 18 projecting outward from the rear portion 16. In this embodiment, the front portion 15 of the rim 13 includes a conic inner wall 151 that tapers rearward. The front annular flange 17 includes a front circumferential surface 171 that is substantially a rearward tapering annular surface merging with a front end of the conic inner wall 151. Further, the front annular flange 17 includes an outer circumferential edge 172 with a bulged surface that faces rearward.

Referring to FIGS. 3 and 4, the stainless annular protective cover 20 includes an annular insertion section 21 and an enveloping section 22 formed on an annular front edge of the annular insertion section 21. The enveloping section 22 includes a rearward extending portion 23 that extends rearward from an annular distal portion of the conic enveloping section 22. The annular insertion section 21 of the stainless annular protective cover 20 is inserted into a space defined by the inner wall 151 of the front portion 15 of the rim 13 with an outer surface of the annular insertion section 21 pressing against the inner wall 151 of the front portion 15 of the rim 13. Meanwhile, the enveloping section 22 of the stainless annular protective cover 20 envelopes the front circumferential surface 171 of the front annular flange 17 with the rearward extending portion 23 extending rearward, best shown in FIG. 4.

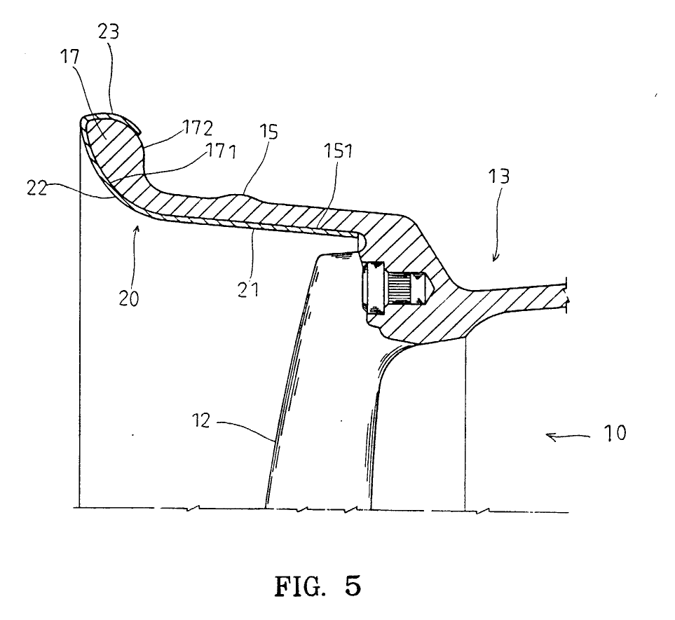

Next, the rearward extending portion 23 is bent rearward to envelope the rearward facing bulged surface of the outer circumferential edge 172 of the front annular flange 17, as shown in FIG. 5. Thus, the stainless annular protective cover 20 is reliably engaged with the rim 13, providing a composite material structure. Thus, the protective cover 20 provides not only a shining effect by the characteristic of stainless steel but also improved surface strength.

Although the invention has been explained in relation to its preferred embodiment, it is to be understood that many other possible modifications and variations can be made without departing from the scope of the invention as hereinafter claimed.

What is claimed is:

1. A vehicle wheel assembly comprising:
a wheel made of aluminum alloy, the wheel including a central hub, a plurality of spokes extending radially outward from the central hub, and a rim, the rim having a front portion, a rear portion, and an intermediate recessed portion, the intermediate recessed portion of the rim including an inner wall with which a distal end of each said spoke is integrally formed, a front annular flange extending outward from the front portion of the rim and having a front circumferential surface and an outer circumferential edge; and
an annular protective cover made of stainless steel, the annular protective cover pressing against an inner wall of the front portion of the rim and enveloping the front circumferential surface and the outer circumferential edge of the front annular flange.

2. The vehicle wheel assembly as claimed in claim 1, wherein the inner wall of the front portion of the rim is a conic surface that tapers rearward.

3. The vehicle wheel assembly as claimed in claim 1, wherein the annular protective cover includes a rearward tapering annular insertion section that presses against the inner wall of the front portion of the rim.

4. The vehicle wheel assembly as claimed in claim 1, wherein the annular protective cover includes an annular insertion section that presses against the inner wall of the front portion of the rim and an enveloping section that envelopes the front circumferential surface and the outer circumferential edge of the front annular flange.

5. The vehicle wheel assembly as claimed in claim 1, wherein the front circumferential surface of the front annular flange on the front portion of the rim is a rearward tapering annular surface merging with the inner wall of the front portion of the rim.

6. The vehicle wheel assembly as claimed in claim 1, wherein the enveloping section of the protective cover includes a rearward extending portion that extends rearward to envelope a rearward facing bulged surface of the outer circumferential edge of the front annular flange.
